(19) United States
(12) Patent Application Publication
(10) Pub. No.: US 2013/0132621 A1
(43) Pub. Date: May 23, 2013

(54) METHOD AND APPARATUS TO SHARE HARDWARE RESOURCES ACROSS STORAGE CONTROLLERS WITHIN A SYSTEM USING RESOURCE SHARING MODULE

(71) Applicant: Ankit Sihare, Bangalore (IN)

(72) Inventor: Ankit Sihare, Bangalore (IN)

(21) Appl. No.: 13/303,564

(22) Filed: Nov. 23, 2011

(51) Int. Cl. G06F 13/14

(52) U.S. Cl. 710/74

(57) ABSTRACT

Disclosed are storage controllers that can share resources (e.g., memory, CPU cycles, I/O bandwidth, etc.). The storage controllers are coupled via a resource sharing cable. When one storage controller determines a resource constraint exists that would prevent completion of a command by the storage controller, the storage controller queries or determines an availability of the resource on a second storage controller. If the resource is available, and can be shared, the storage controller uses the resource on the second storage controller to complete the command.

### BACKGROUND OF THE INVENTION

Mass storage systems continue to provide increased storage capacities to satisfy user demands. Photo and movie storage, and photo and movie sharing are examples of applications that fuel the growth in demand for larger and larger storage systems.

A solution to these increasing demands is the use of arrays of multiple inexpensive disks. These arrays may be configured in ways that provide redundancy and error recovery without any loss of data. These arrays may also be configured to increase read and write performance by allowing data to be read or written simultaneously to multiple disk drives. These arrays may also be configured to allow “hot-swapping” which allows a failed disk to be replaced without interrupting the storage services of the array. Whether or not any redundancy is provided, these arrays are commonly referred to as redundant arrays of independent disks (or more commonly by the acronym RAID). The 1987 publication by David A. Patterson, et al., from the University of California at Berkeley titled “A Case for Redundant Arrays of Inexpensive Disks (RAID)” discusses the fundamental concepts and levels of RAID technology.

RAID storage systems typically utilize a controller that shields the user or host system from the details of managing the storage array. The controller makes the storage array appear as one or more disk drives (or volumes). This is accomplished in spite of the fact that the data (or redundant data) for a particular volume may be spread across multiple disk drives.

### SUMMARY OF THE INVENTION

An embodiment of the invention may therefore comprise a method of operating a storage controller, comprising: determining a resource constraint of a first resource on a first storage controller that would prevent completion of a command by said first storage controller; receiving, via a resource sharing cable, an indicator of an availability of said first resource on a second storage controller; and, in response to the indicator of availability of said first resource on said second storage controller, using, by said first storage controller, said first resource on said second storage controller to complete said command.

An embodiment of the invention may therefore further comprise a storage system, comprising: a first storage controller having a first resource on said first storage controller; and, a second storage controller having said first resource on said second storage controller, the second storage controller coupled to the first storage controller via a resource sharing cable, the first storage controller to determine a resource constraint of said first resource on said first storage controller that would prevent completion of a command by said first storage controller, the first storage controller to receive, via said resource sharing cable, an indicator of an availability of said first resource on said second storage controller, said first storage controller to use said first resource on said second storage controller to complete said command.

### BRIEF DESCRIPTION OF THE DRAWINGS

FIG. 1 is a block diagram of a storage system.

FIG. 2 is a flowchart of a method of operating a storage system.

FIG. 3 is a flowchart of a method of operating a storage system.

FIG. 4 is a block diagram of computer system.

### DETAILED DESCRIPTION OF THE EMBODIMENTS

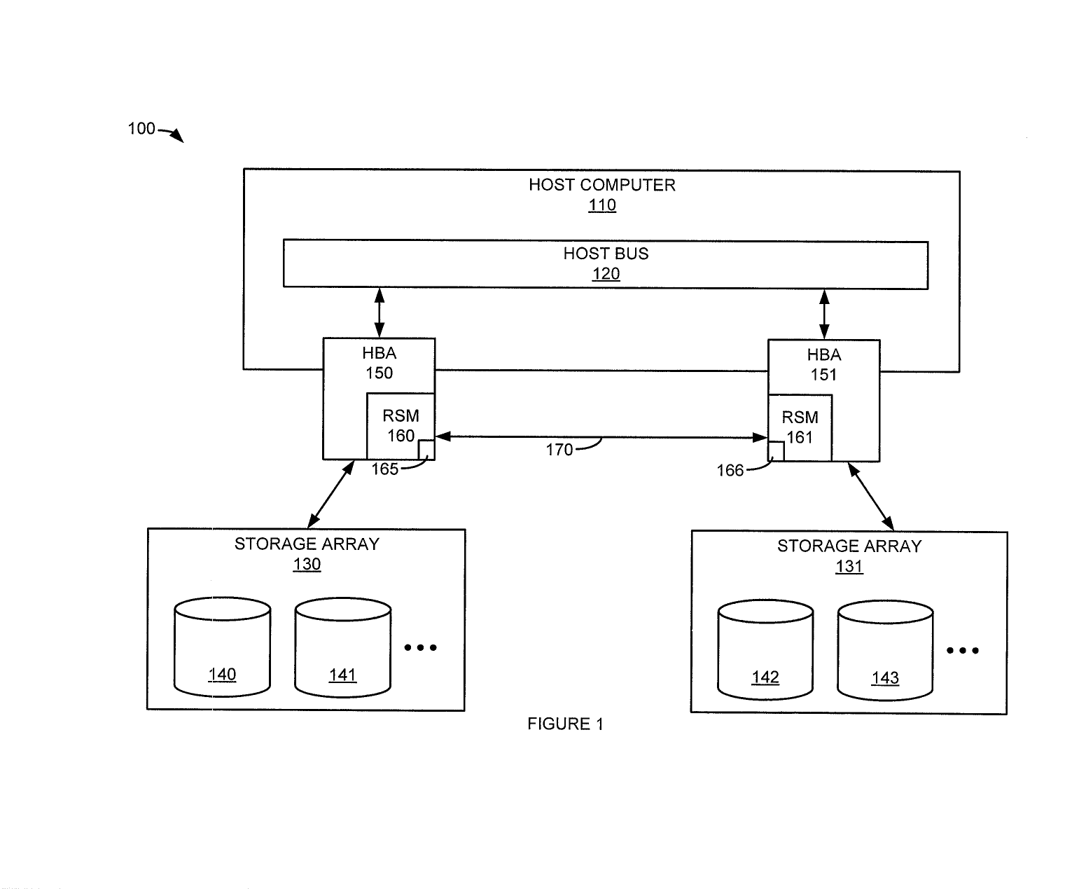

FIG. 1 is a block diagram of a storage system. In FIG. 1, storage system 100 comprises host computer 110, host bus adapter (HBA) 150, HBA 151, storage array 130, storage array 131, and resource sharing cable 170. Host computer 110 includes host bus 120. HBA 150 includes resource sharing module (RSM) 160. HBA 151 includes RSM 161. Storage array 130 includes a plurality of disk drives 140-141. Storage array 131 includes a plurality of disk drives 142-143.

HBA 150 is operatively coupled to host bus 120. HBA 151 is operatively coupled to host bus 120. HBA 150 is operatively coupled to storage array 130. HBA 151 is operatively coupled to storage array 131. Thus, host computer 110 may exchange I/O data and commands with storage array 130 via host bus 120 and HBA 150. Host computer 110 may exchange I/O data and commands with storage array 131 via host bus 120 and HBA 151. RSM 160 is operatively coupled to RSM 161 via resource sharing cable 170. RSM 160 includes resource table 165. RSM 161 includes resource table 166. In an embodiment, host bus 120 is a PCI bus.

Host bus adapters 150-151 (a.k.a., host controller, storage controller, or host adapter) connect a host computer 110 to storage arrays 130-131, respectively. HBAs 150-151 bridge the physical, logical, and protocol differences between the host computer's internal bus (host bus 120) and external communication link(s). HBAs 150-151 may contain all the electronics and firmware required to execute transactions on the external communication link(s). In an embodiment, HBAs 150-151 could be compatible with Fiber Channel, high speed Ethernet network interfaces, InfiniBand, or Serial Attached SCSI (SAS).

In FIG. 1, two HBA's 150-151 are shown, and two storage arrays 130-131 are shown. However, this is merely exemplary. It should be understood that storage system 100 may have as little as one storage array. It should also be understood that storage system 100 may have more than two HBA's and/or storage arrays. In addition, the number of HBA's and storage arrays in storage system 100 need not match each other.

In an embodiment, RSM 160 maintains information about the resources available on HBA 150. RSM 161 maintains information about the resources available on HBA 151. RSM 160 and RSM 161 also share information about the resources available on HBA 150 and HBA 151 with RSM 161 and RSM 160, respectively, via resource sharing cable 170. RSM 160 and RSM 161 may be software enabled modules that control resource tables 165 and 166 within HBA 150 and HBA 151, respectively. RSM 160 and RSM 161 may enable the resources available in one HBA 150-151 to be shared with another HBA 150-151 via resource sharing cable 170. Resource sharing cable 170 may be a high speed storage protocol compliant cable that can carry signals (e.g., SAS signals) from one HBA 150-151 to another HBA 150-151.

In an embodiment, resource tables 165-166 have real-time information about the availability of resources on HBA's 150-151. Resource tables 165-166 may maintain the real-time information about the availability of resources using a polling process. The polling process may periodically request firmware running on HBA's 150-151 to gather information about current resource availability.

When an HBA 150-151 detects a resource constraint, HBA 150-151 may obtain resource information about available resources on the other HBA 150-151. HBA 150-151 may obtain resource information about available resources on the other HBA 150-151 via RSM 160-161 and resource sharing cable 170. HBA 150-151 may request, or use, available resources on the other HBA 150-151 via RSM 160-161 and resource sharing cable 170. HBA 150-151 may request or use available resources on the other HBA 150-151 to complete a resource constrained operation. When a resource is allocated to the other HBA 150-151, the resource tables 165-166 of both the “giving” and “receiving” HBA 150-151 may be updated appropriately to reflect fewer resources on the “giving” HBA 150-151 and the additional resources on the “receiving” HBA 150-151.

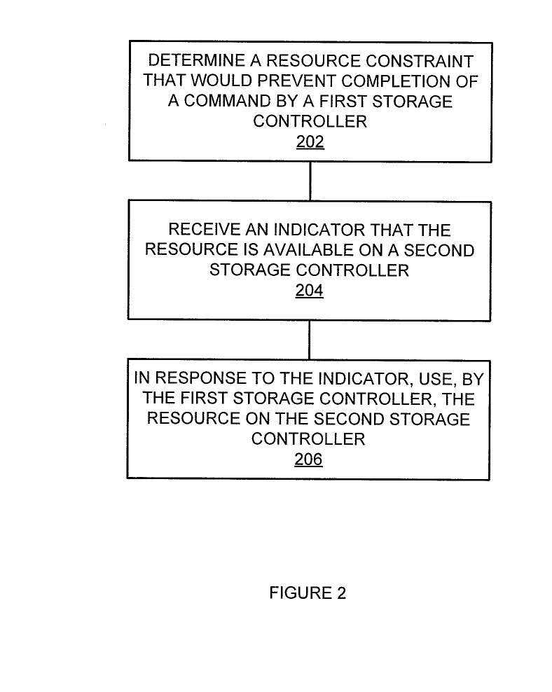

It should be understood that resources that may be shared include are any hardware resource that HBA's 150-151 may use. This includes, but is not limited to: memory, core, CPU cycles, message units, data buses, registers, etc. It should also be understood that although only two HBA';s are shown in FIG. 2, more than two HBA's 150-151 may be coupled in order to share resources. Coupling more than two HBA's 150-151 by one or more resource sharing cables 170 enables resource sharing between more than two HBA's 150-151.

It should also be understood that by using resource sharing cable 170 to share resources and to provide information about available resources to HBA's 150-151, the sharing of resources is not dependent on host bus 120. Thus, sharing of resources is not dependent on the available bandwidth of host bus 120.

In an embodiment, HBA 150 may receive an I/O command from host computer 110 via host bus 120. HBA 150 may determine that one or more resources are over utilized, unavailable, or otherwise constrained such that the command cannot be completed by HBA 150. In response to determining that a lack of one or more resources will prevent the completion of the command, HBA 150 may query RSM 160 to determine if HBA 151 has the one or more resources available and can share them. RSM 160 may receive an indicator or indicators of whether the one or more resources is available from RSM 161 and/or HBA 151 via resource sharing cable 170. In response to the indicator or indicators, RSM 160 and RSM 161 may negotiate and/or enable the sharing of the one or more resources by HBA 151 so that HBA 150 may use those resources to complete the command.

In an embodiment, the one or more resources that HBA 151 shares with HBA 150 are shared via resource sharing cable 170. RSM 160 may determine if HBA 151 has the one or more resources available by accessing resource table 166 via resource sharing cable 170. Likewise, RSM 161 may allow access to resource table 165 via resource sharing cable 170. The contents of resource tables 165 and 166 may be communicated between RSM 160 and RSM 161 periodically using a polling process. In other words, HBA 150 may poll HBA 151 via resource sharing cable 170 in order to receive information stored in resource table 166 about the one or more resources.

In response to a request or other indicator from HBA 150, HBA 151 may allocate the one or more resources to HBA 150. When HBA 150 completes the command, HBA 151 may deallocate the one or more resources from HBA 150.

FIG. 2 is a flowchart of a method of operating a storage system. The steps illustrated in FIG. 2 may be performed by one or more elements of storage system 100. A resource constraint that would prevent the completion of a command by a first storage controller is determined (202). For example, a command from host computer 110 that is sent to HBA 150 may not be able to be completed by HBA 150 due to a resource constraint. HBA 150 may detect or determine this condition by referencing resource table 165. In response to determining that HBA 150 cannot complete the command, HBA 150 (via RSM 160) may query resource table 166. In another example, in response to determining that HBA 150 cannot complete the command, HBA 150 (via RSM 160) may query resource table 165 and/or RSM 160 to determine whether the constrained resource is available on HBA 151.

An indicator that the resource is available on a second storage controller is received (204). For example, as part of a regular polling process, HBA 150 may receive indicators of what resources are available (or not available) from HBA 151. These indicators may be communicated between HBA 150 and HBA 151 using resource sharing cable 170. In another example, HBA 150 may receive indicators of what resources are available (or not available) from HBA 151 when HBA 150 queries HBA 151 in response to determining that HBA 150 cannot complete the command because of a resource constraint.

In response to the indicator, the first storage controller uses the resource on the second controller (206). For example, in response to an indicator from HBA 151 that the constrained resource on HBA 151 is available, HBA 150 may use a resource on HBA 151 to complete the command. In another example, if the constrained resource is memory, in response to an indicator from HBA 151 that HBA 151 has memory available, HBA 150 may use memory on HBA 151 to complete the command. The data being stored/retrieved to/from HBA 151 may be communicated via resource sharing cable 170.

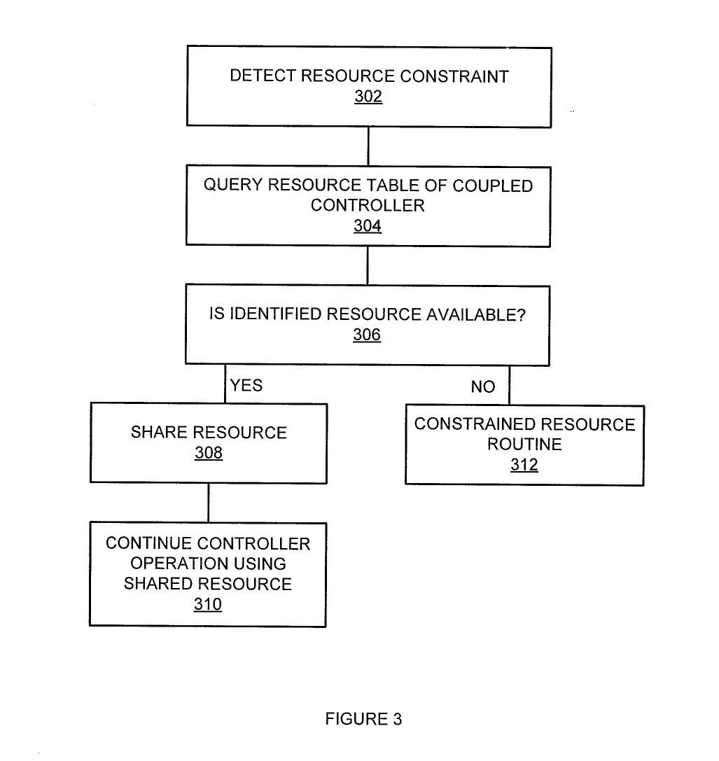

FIG. 3 is a flowchart of a method of operating a storage system. The steps illustrated in FIG. 3 may be performed by one or more elements of storage system 100. A resource constraint is detected (302). For example, HBA 150 may detect that it is short of a particular resource. HBA 150 may detect that is cannot complete a command because it is short of a particular resource. HBA 150 may detect that it is short of a particular resource by referring to information stored in resource table 165.

A resource table of a couple controller is queried (304). For example, HBA 150 (and/or RSM 160) may query resource table 166 of HBA 151. HBA 150 (and/or RSM 160) may query resource table 166 of HBA 151 as part of a polling process, or in response to the detection of the resource constraint made in block 302. HBA 150 (and/or RSM 160) may query resource table 166 of HBA 151 to determine if HBA 151 can share the resource identified as being constrained in block 302.

If the identified resource is available, flow proceeds to block 308. If the identified resource is not available, flow proceeds to block 312 (306). If the identified resource is available, the resource is shared (306). For example, if the constrained resource is memory, and HBA 151 has memory space it can share, HBA 151 allocates memory space that HBA 150 may use. Operation of the controller is continued using the shared resource (310). For example, after HBA 151 allocates memory space for HBA 150 to use, HBA 150 may continue operation using that memory space. HBA 150 may use that memory space to complete one or more commands. At some later time, HBA 150 and/or HBA 151 may deallocate that memory so that HBA 150 and HBA 151 are no longer sharing the allocated memory.

If the identified resource is not available, a constrained resource routine is executed (312). For example, if the constrained resource on HBA 150 is not available on HBA 151, HBA 150 will execute a routine to handle constrained resource issue.

The methods, systems, networks, devices, equipment, and functions described above may be implemented with or executed by one or more computer systems. The methods described above may also be stored on a computer readable medium. Many of the elements of storage system 100, may be, comprise, or include computers systems. This includes, but is not limited to host computer 110, HBA 150, HBA 151, storage array 130, and storage array 131.

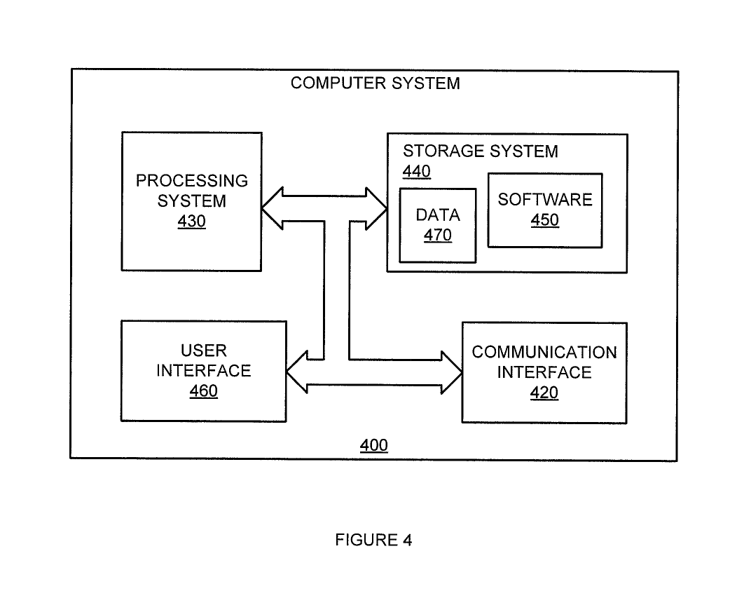

FIG. 4 illustrates a block diagram of a computer system. Computer system 400 includes communication interface 420, processing system 430, storage system 440, and user interface 460. Processing system 430 is operatively coupled to storage system 440. Storage system 440 stores software 450 and data 470. Processing system 430 is operatively coupled to communication interface 420 and user interface 460. Computer system 400 may comprise a programmed general-purpose computer. Computer system 400 may include a microprocessor. Computer system 400 may comprise programmable or special purpose circuitry. Computer system 400 may be distributed among multiple devices, processors, storage, and/or interfaces that together comprise elements 420-470.

Communication interface 420 may comprise a network interface, modem, port, bus, link, transceiver, or other communication device. Communication interface 420 may be distributed among multiple communication devices. Processing system 430 may comprise a microprocessor, microcontroller, logic circuit, or other processing device. Processing system 430 may be distributed among multiple processing devices. User interface 460 may comprise a keyboard, mouse, voice recognition interface, microphone and speakers, graphical display, touch screen, or other type of user interface device. User interface 460 may be distributed among multiple interface devices. Storage system 440 may comprise a disk, tape, integrated circuit, RAM, ROM, network storage, server, or other memory function. Storage system 440 may be a computer readable medium. Storage system 440 may be distributed among multiple memory devices.

Processing system 430 retrieves and executes software 450 from storage system 440. Processing system 430 may retrieve and store data 470. Processing system 430 may also retrieve and store data via communication interface 420. Processing system 430 may create or modify software 450 or data 470 to achieve a tangible result. Processing system 430 may control communication interface 420 or user interface 460 to achieve a tangible result. Processing system may retrieve and execute remotely stored software via communication interface 420.

Software 450 and remotely stored software may comprise an operating system, utilities, drivers, networking software, and other software typically executed by a computer system. Software 450 may comprise an application program, applet, firmware, or other form of machine-readable processing instructions typically executed by a computer system. When executed by processing system 430, software 450 or remotely stored software may direct computer system 400 to operate as described herein.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of operating a storage controller, comprising:
determining a resource constraint of a first resource on a first storage controller that would prevent completion of a command by said first storage controller;
receiving, via a resource sharing cable, an indicator of an availability of said first resource on a second storage controller; and,
in response to the indicator of availability of said first resource on said second storage controller, using, by said first storage controller, said first resource on said second storage controller to complete said command.

2. The method of claim 1, wherein said first resource on said second storage controller is coupled to said first storage controller for use by said first storage controller via said resource sharing cable.

3. The method of claim 2, wherein said first storage controller maintains a first resource table that is accessible to said second storage controller via said resource sharing cable.

4. The method of claim 3, wherein said second storage controller maintains a second resource table that is accessible to said first storage controller via said resource sharing cable.

5. The method of claim 4, wherein said first storage controller polls said second storage controller to receive, via said resource sharing cable, information about said first resource on said first storage controller stored in said second resource table.

6. The method of claim 1, further comprising:
allocating, by said second controller, said first resource on said second storage controller to said first storage controller.

7. The method of claim 6, further comprising:
in response to said command completing, deallocating, by said second controller, said first resource on said second storage controller from said first storage controller.

8. A storage system, comprising:
a first storage controller having a first resource on said first storage controller; and,
a second storage controller having said first resource on said second storage controller, the second storage controller coupled to the first storage controller via a resource sharing cable, the first storage controller to determine a resource constraint of said first resource on said first storage controller that would prevent completion of a command by said first storage controller, the first storage controller to receive, via said resource sharing cable, an indicator of an availability of said first resource on said second storage controller, said first storage controller to use said first resource on said second storage controller to complete said command.

9. The storage system of claim 8, wherein said first resource on said second storage controller is coupled to said first storage controller for use by said first storage controller via said resource sharing cable.

10. The storage system of claim 9, wherein said first storage controller is to maintain a first resource table that is accessible to said second storage controller via said resource sharing cable.

11. The storage system of claim 10, wherein said second storage controller is to maintain a second resource table that is accessible to said first storage controller via said resource sharing cable.

12. The storage system of claim 11, wherein said first storage controller is to poll said second storage controller to receive, via said resource sharing cable, information about said first resource on said first storage controller stored in said second resource table.

13. The storage system of claim 8, wherein said second controller is to allocate said first resource on said second storage controller to said first storage controller.

14. The storage system of claim 13, wherein said second controller is to deallocate, in response to said command completing, said first resource on said second storage controller from said first storage controller.

15. A non-transitory computer readable medium having instructions stored thereon for operating a storage controller that, when executed by a computer, at least instruct the computer to:
determine a resource constraint of a first resource on a first storage controller that would prevent completion of a command by said first storage controller;
receive, via a resource sharing cable, an indicator of an availability of said first resource on a second storage controller; and,
in response to the indicator of availability of said first resource on said second storage controller, use, by said first storage controller, said first resource on said second storage controller to complete said command.

16. The non-transitory computer readable medium of claim 15, wherein said first resource on said second storage controller is coupled to said first storage controller for use by said first storage controller via said resource sharing cable.

17. The non-transitory computer readable medium of claim 16, wherein said first storage controller maintains a first resource table that is accessible to said second storage controller via said resource sharing cable.

18. The non-transitory computer readable medium of claim 17, wherein said second storage controller maintains a second resource table that is accessible to said first storage controller via said resource sharing cable.

19. The non-transitory computer readable medium of claim 18, wherein said first storage controller polls said second storage controller to receive, via said resource sharing cable, information about said first resource on said first storage controller stored in said second resource table.

20. The non-transitory computer readable medium of claim 15, wherein the computer is further instructed to:
allocate, by said second controller, said first resource on said second storage controller to said first storage controller.
